(19) United States
(12) Patent Application Publication
(10) Pub. No.: US 2026/0097652 A1
(43) Pub. Date: Apr. 9, 2026

(54) METHOD AND APPARATUS FOR PROVIDING ADJUSTABLE PARKING GUIDE LINE TO ASSIST IN PARKING OF VEHICLE

(71) Applicants: Hyundai Motor Company, Seoul (KR); Kia Corporation, Seoul (KR)

(72) Inventor: Min Chul Kang, Hwaseong (KR)

(21) Appl. No.: 19/263,383

(22) Filed: Jul. 8, 2025

(30) Foreign Application Priority Data
Oct. 8, 2024 (KR) 10-2024-0136513

(51) Int. Cl. B60K 35/28; G06T 11/20; G06V 20/58

(52) U.S. Cl. CPC B60K 35/28; G06T 11/23; G06V 20/586; B60K 2360/16; B60K 2360/21

(57) ABSTRACT

A method and apparatus for providing an adjustable parking guide line based on recognizing a parking space can assist a driver of a vehicle in parking the vehicle. The method of providing the adjustable parking guide line through a display device of the vehicle includes: recognizing a parking space using an image from a camera installed at the rear of a vehicle, and obtaining a size of the parking space from the image; generating an adjusted parking guide line by adjusting a size of a current parking guide line based on the size of the parking space, when the size of the parking space is different from the size of the current parking guide line; and displaying the adjusted parking guide line on the display device.

### CROSS REFERENCE TO RELATED APPLICATION

The present application claims under 35 U.S.C. § 119(a) the benefit of Korean Patent Application No. 10-2024-0136513, filed on Oct. 8, 2024, the entire contents of which are incorporated by reference herein.

### BACKGROUND

### (a) Technical Field

The present disclosure relates to a method and apparatus for providing an adjustable parking guide line to assist in parking a vehicle, more particularly, to the method of apparatus for providing the adjustable parking guide line based on recognition of a parking space and to display the parking guide line on a display device to assist a driver in parking of the vehicle.

### (b) Description of the Related Art

Recently, there has been a proliferation of devices that aim to improve consumer convenience as well as consumer satisfaction regarding the performance of automobiles.

As an example, there has been wide distribution of front/rear/left/right cameras for parking assistance and display devices such as a surround view monitor (SVM) and a rear view monitor (RVM) by which the status of an automobile can be ascertained at a glance.

When parking in the front or rear (e.g., pulling a vehicle forward, or backing into a parking space), a driver can see obstacles around the vehicle and ascertain distances to the obstacles through cameras, distance measuring sensors, and display devices provided in the front or rear of the vehicle.

Previously, for the purpose of recognizing such obstacles during parking, limited information was provided, such as simply displaying front or rear scenes on a display device, simply displaying trajectories according to steering directions, or simply displaying distances.

However, the vehicle and parking environments have continued to change over time. For example, in 1990, a typical standard size for a parking space was about 2.3 meters wide and 5.0 meters long for compact cars, but in 2008, the standard size for an expanded parking space has increased to a size of 2.5 meters by 5.1 meters. In 2014, installation of expanded parking spaces of more than 30% in new facilities was made mandatory in Korea and other countries.

In accordance with specifications of parking guide lines that are changing in various ways, it would be desirable to provide parking guide lines that can be adjusted to the sizes of various parking spaces and thus are more intuitive and can increase user satisfaction compared to conventional technologies, rather than parking guide lines with fixed sizes as previously used.

### SUMMARY

The present disclosure is directed to providing a method and apparatus for providing an adjustable parking guide line based on recognition of parking space to assist a driver in parking a vehicle.

The technical objects of the present disclosure are not limited to those described above, and other technical objects not mentioned above may be understood clearly by those skilled in the art from the descriptions given below. According to the present disclosure, an apparatus for providing a parking guide line through a display device of a vehicle includes: at least one memory configured to store instructions; and at least one processor, wherein the at least one processor executes the instructions for causing the processor to perform the steps of: recognizing a parking space using an image from a camera installed at the rear of a vehicle, and obtaining a size of the parking space from the image; generating an adjusted parking guide line by adjusting a size of a current parking guide line based on the size of the parking space, when the size of the parking space is different from the size of the current parking guide line; and displaying the adjusted parking guide line on the display device.

According to another aspect of the present disclosure, the present disclosure provides an apparatus for providing a parking guide line, comprising: at least one memory configured to store instructions; and at least one processor, wherein the at least one processor executes the instructions for causing the processor to perform the steps of: recognizing a parking space using an image from a camera installed at the rear of a vehicle, and obtaining a size of the parking space from the image; and generating an adjusted parking guide line by adjusting a size of a current parking guide line based on the size of the parking space, when the size of the parking space is different from the size of the current parking guide line.

According to the present disclosure, a method of providing a parking guide line through a display device of a vehicle includes steps of: recognizing, by a processor, a parking space using an image from a camera installed at the rear of a vehicle, and obtaining a size of the parking space from the image; generating, by the processor, an adjusted parking guide line by adjusting a size of a current parking guide line based on the size of the parking space, when the size of the parking space is different from the size of the current parking guide line; and displaying, by the processor, the adjusted parking guide line on the display device.

According to a further aspect of the present disclosure, the present disclosure provides a method of providing a parking guide line, the method comprising: recognizing a parking space using an image from a camera installed at the rear of a vehicle, and obtaining a size of the parking space from the image; and generating an adjusted parking guide line by adjusting a size of a current parking guide line based on the size of the parking space, when the size of the parking space is different from the size of the current parking guide line.

According to an embodiment of the present disclosure, it is possible to provide a parking guide line that takes into account special parking areas such as disabled parking areas and parking spaces with various specifications, thereby increasing driver satisfaction.

The effects of the present disclosure are not limited to the effects mentioned above, and other effects not mentioned will be clearly understood by those skilled in the art from the following description.

### BRIEF DESCRIPTION OF THE DRAWINGS

FIG. 1 is a diagram illustrating a rear view image of a vehicle and an overlaid parking guide line provided to a driver through a display device of the vehicle.

FIG. 2 is a block diagram illustrating a parking guide line providing apparatus according to an embodiment of the present disclosure.

FIG. 3 is a diagram illustrating a parking space recognized by a parking space recognizer.

FIG. 4 is a diagram illustrating the form of a current parking guide line.

FIG. 5 is a diagram illustrating a case of a disabled parking space with a wheel stop.

FIG. 6 is a diagram illustrating a case in which there are a plurality of wheel stops and a plurality of left and right parking lines.

FIG. 7 is a diagram illustrating T-shaped left and right parking lines in a camera image.

FIG. 8 is a diagram illustrating a parking guide line according to the risk of collision with a surrounding obstacle.

FIG. 9A is a diagram illustrating the appearance of a parking guide line before recognition of a slope of the ground, and FIG. 9B is a diagram illustrating the appearance of a parking guide line reflecting the slope of the ground.

FIG. 10 is a flowchart of a method of providing a parking guide line according to an embodiment of the present disclosure.

FIG. 11 is a block diagram schematically illustrating an example vehicle that can be used to implement the method or device according to embodiments of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the following description, like reference numerals designate like elements, although the elements are shown in different drawings. Furthermore, for clarity and for brevity, the following description of various exemplary embodiments will omit a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. The terms such as “unit,” “module,” and the like refer to units in which at least one function or operation is processed and they may be implemented by hardware, software, or a combination thereof.

The description of the present disclosure to be presented below in conjunction with the accompanying drawings is directed to describe exemplary embodiments of the present disclosure and is not intended to represent the only embodiments in which the technical idea of the present disclosure may be practiced.

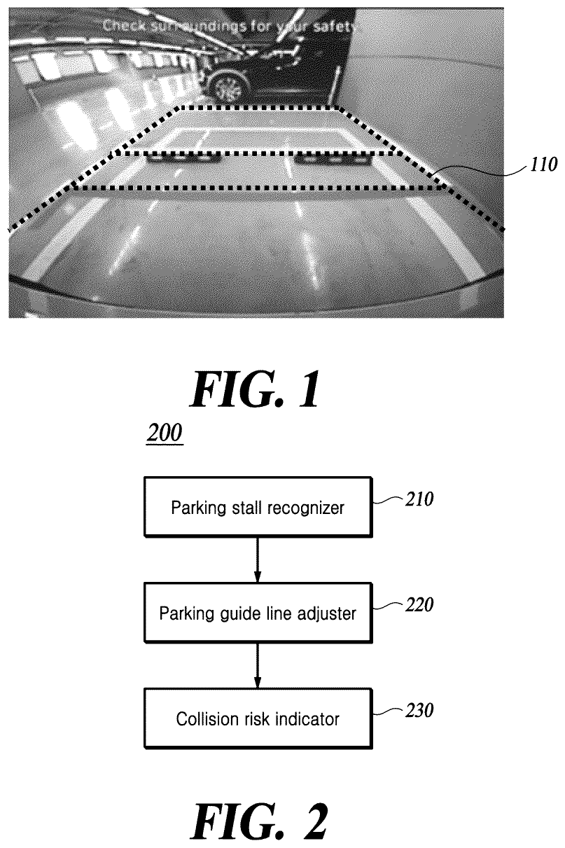

FIG. 1 is a diagram illustrating an example of a rear view image of a vehicle and an overlaid parking guide line provided to a driver through a display device of the vehicle.

FIG. 1 illustrates parking guide lines 110 that may be provided in a case where variations in the dimensions of parking spaces are not taken into account.

FIG. 2 is a block diagram illustrating a parking guide line providing apparatus 200 according to an embodiment of the present disclosure.

The parking guide line providing apparatus 200 according to an embodiment of the present disclosure includes a parking space recognizer 210, a parking guide line adjuster 220, and a collision risk indicator 230. Not all blocks illustrated in FIG. 2 are essential components, and some blocks included in the parking guide line providing apparatus 200 may be added, changed, or deleted in other embodiments. The components illustrated in FIG. 2 represent functionally separate elements, and one or more components may be integrated in an actual physical environment.

Each of the above elements 210, 220, and 230 may constitute modules and/or devices of the parking guide line providing apparatus 200, which may be a controller. For example, the above units of the parking guide line providing apparatus 200 may constitute hardware components that form part of a controller (e.g., modules or devices of a high-level controller), or may constitute individual controllers each having a processor and memory. The parking guide line providing apparatus 200 may include one or more processors and memory.

The parking space recognizer 210 recognizes a parking space using an image of a camera installed at the rear of a vehicle, and acquires the size of the parking space from the image of the camera.

The parking space recognizer 210 recognizes a parking space at the rear of the vehicle from the image of the camera using depth estimation (DE) and a distance map (DM).

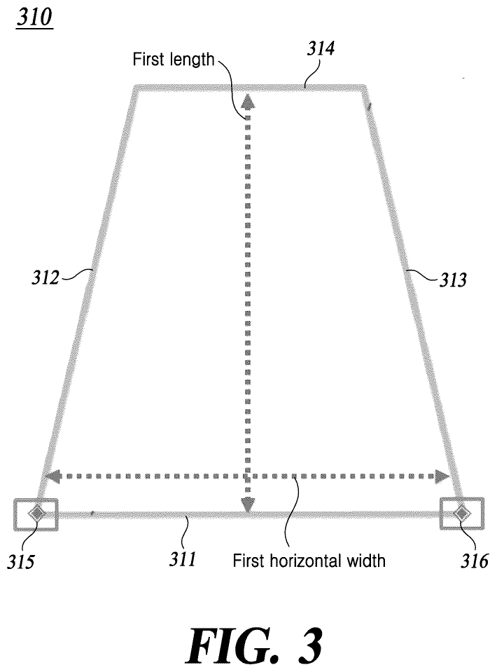

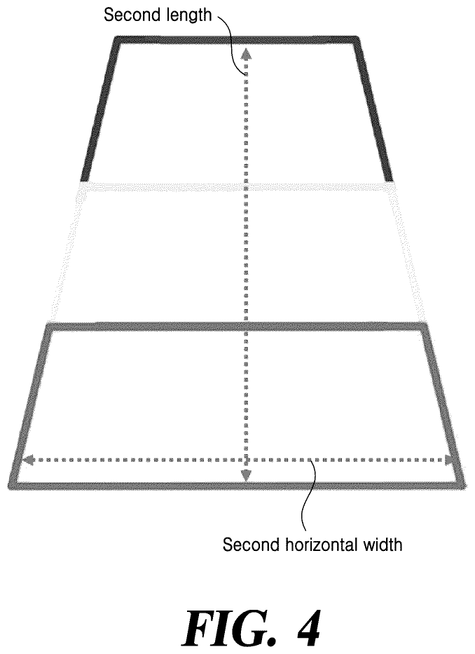

FIG. 3 is a diagram illustrating a parking space recognized by the parking space recognizer 210, and FIG. 4 is a diagram illustrating the form of a current parking guide line.

The parking space recognizer 210 recognizes a front horizontal parking line 311, a left vertical parking line 312, a right vertical parking line 313, and a rear horizontal parking line 314 from a camera image.

The parking space recognizer 210 may recognize a line connecting a forward starting point 315 of the left vertical parking line 312 and a forward starting point 316 of the right vertical parking line 313 as the front horizontal parking line 311.

The parking space recognizer 210 may recognize the left vertical parking line 312 and the right vertical parking line 313 from the camera image, and may recognize a line connecting a rearward starting point of the left vertical parking line 312 and a rearward starting point of the right vertical parking line 313 as the rear horizontal parking line 314 of the parking space.

Here, the forward direction means the direction close to the camera of the vehicle, and the rearward direction means the direction far from the camera of the vehicle.

Since the method of recognizing a parking space 310 based on depth estimation and a distance map departs from the scope of the present disclosure, a detailed description thereof will be omitted.

The parking guide line adjuster 220 adjusts the size of the current parking guide line based on the size of the parking space 310 to generate an adjusted parking guide line when the size of the parking space 310 is different from the size of the current parking guide line.

The parking guide line adjuster 220 recognizes the distance between the left vertical parking line 312 and the right vertical parking line 313 as a first horizontal width of the parking space, and recognizes the distance between the front horizontal parking line 311 and the rear horizontal parking line 314 as a first length of the parking space 310.

The parking guide line adjuster 220 generates an adjusted parking guide line by increasing the horizontal width of the current parking guide line to the first horizontal width when the first horizontal width of the parking space 310 is greater than a second horizontal width that is the width of the current parking guide line.

In addition, the parking guide line adjuster 220 generates an adjusted parking guide line by reducing the horizontal width of the current parking guide line to the first horizontal width when the first horizontal width of the parking space 310 is less than the second horizontal width.

The parking guide line adjuster 220 generates an adjusted parking guide line by adjusting the length of the current parking guide line based on the first length of the parking space 310.

That is, the parking guide line adjuster 220 generates an adjusted parking guide line by increasing the length of the current parking guide line to the first length when the first length of the parking space 310 is greater than a second length that is the length of the current parking guide line.

In addition, the parking guide line adjuster 220 generates an adjusted parking guide line by reducing the length of the current parking guide line to the first length when the first length of the parking space 310 is less than the second length of the current parking guide line.

The parking guide line adjuster 220 sets a minimum length and a maximum length for a parking guide line such that the second length of the parking guide line falls between the minimum length and the maximum length.

The parking guide line adjuster 220 sets a minimum horizontal width and a maximum horizontal width for the parking guide line such that the second horizontal width of the parking guide line falls between the minimum horizontal width and the maximum horizontal width.

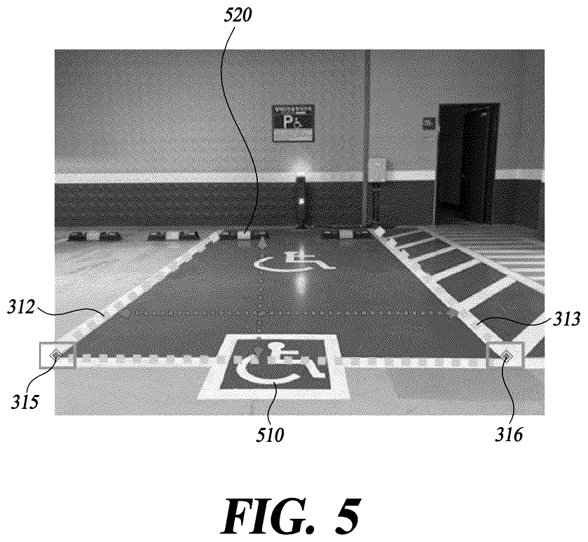

FIG. 5 is a diagram illustrating a case of a disabled parking space with a wheel stop.

The parking space recognizer 210 removes unnecessary noise 510 unrelated to the parking space 310 from the camera image. Here, the noise 510 may be various marks such as a disabled space mark, and the noise 510 may be filtered out through learning. Since the detailed description thereof departs from the scope of the present disclosure, a description thereof will be omitted.

The parking space recognizer 210 recognizes the wheel stop 520 from the camera image and recognizes the line corresponding to the wheel stop 520 as the rear horizontal parking line 314 of the parking space 310.

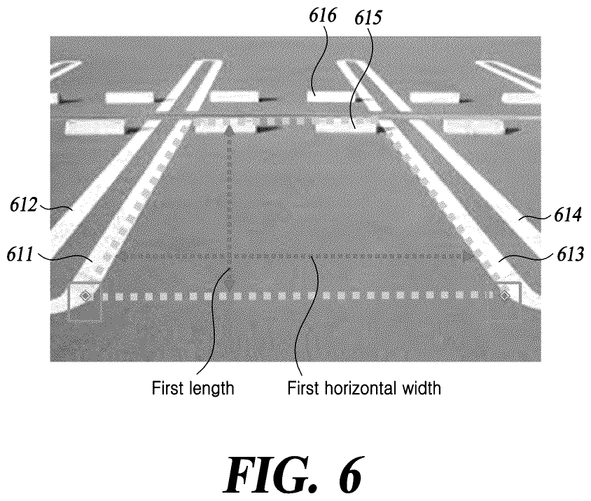

FIG. 6 is a diagram illustrating a case in which there are a plurality of wheel stops and a plurality of left and right parking lines.

As illustrated in FIG. 6, when there is a plurality of left vertical parking lines 611 and 612, the parking space recognizer 210 recognizes the left vertical parking line 611 closer to the camera of the vehicle between the left vertical parking lines 611 and 612 as the left vertical parking line 312 of the parking space 310.

When there is a plurality of right vertical parking lines 613 and 614, the parking space recognizer 210 recognizes the right vertical parking line 613 closer to the camera of the vehicle between the right vertical parking lines 613 and 614 as the right vertical parking line 313 of the parking space 310.

When the parking space recognizer 210 recognizes a plurality of wheel stops 615 and 616 or a plurality of rear horizontal parking lines in the camera image, the parking space recognizer 210 recognizes the wheel stop 615 or rear horizontal parking line that is closest to the parking space 310 in the forward direction of the parking space 310 as the rear horizontal parking line 314 of the parking space 310. Here, the forward direction means the direction closer to the camera of the vehicle.

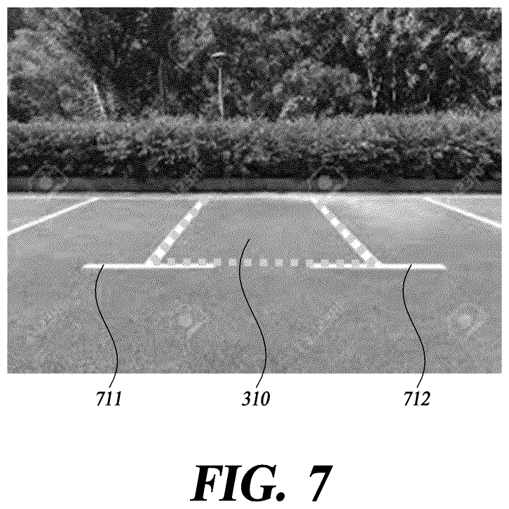

FIG. 7 is a diagram illustrating an example of T-shaped left and right parking lines in a camera image. The parking space recognizer 210 recognizes a left T-line 711 and a right T-line 712 formed in a T shape from the front to the rear in the camera image, and recognizes the inner area between the left T-line 711 and the right T-line 712 as a parking space 310.

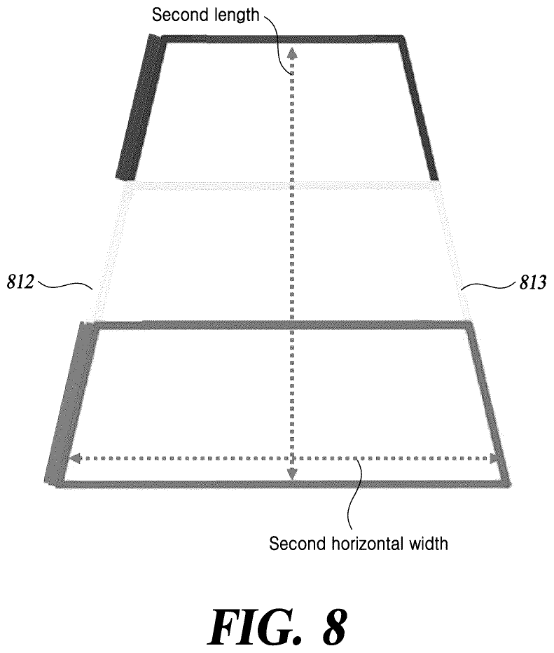

FIG. 8 is a diagram illustrating an example of a parking guide line according to the risk of collision with a surrounding obstacle.

The collision risk indicator 230 determines a risk of collision between the vehicle and an obstacle around the parking space 310, and visually indicates the collision risk at at least one of the left vertical parking line 312 and the right vertical parking line 313 of the parking space 310 on the parking guide line.

The collision risk indicator 230 indicates a left parking guide line 812 corresponding to the left vertical parking line 312 and a right parking guide line corresponding to the right vertical parking line 313 with different thicknesses depending on degrees of collision risk related to the left vertical parking line 312 and the right vertical parking line 313.

Upon determining that the collision risk at the location corresponding to the left vertical parking line 312 is greater than the collision risk at the location corresponding to the right vertical parking line 313 by a preset magnitude or more, the collision risk indicator 230 indicates the left parking guide line 812 thicker than the right parking guide line 813, as illustrated in FIG. 8.

For example, a pillar adjacent to the left vertical parking line 312 or the right vertical parking line 313 in the parking space 310 corresponds to a surrounding obstacle with a risk of collision.

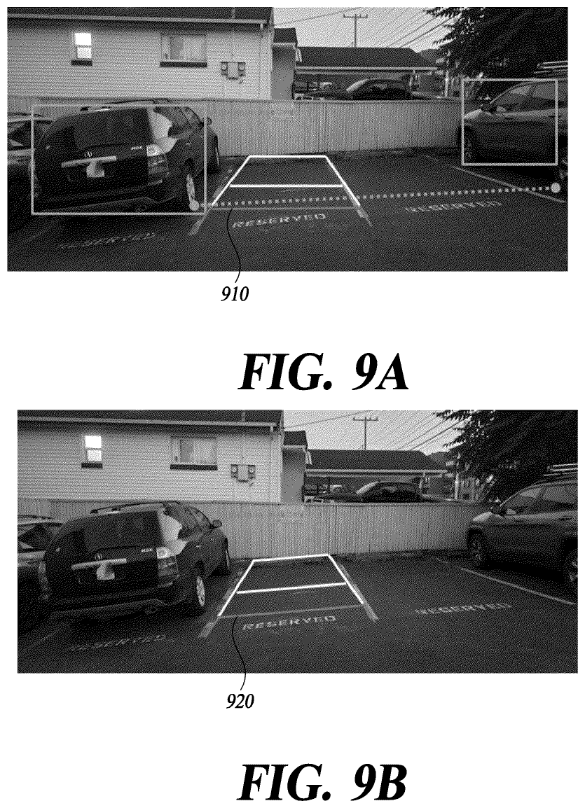

FIG. 9A is a diagram illustrating the appearance of a parking guide line before recognition of a slope of the ground, and FIG. 9B is a diagram illustrating the appearance of a parking guide line reflecting the slope of the ground.

When the parking guide line adjuster 220 determines that there is a slope on the ground where the parking space 310 is located with respect to the vehicle, the parking guide line adjuster 220 adjusts the direction of the parking guide line depending on the slope of the ground.

The parking guide line adjuster 220 determines whether there is a slope on the ground from the camera image. The slope of the ground may be ascertained from the positions of the wheels of neighboring vehicles, or may be ascertained from the slope of a surrounding fence and the like.

Since the technique of obtaining a slope of the ground from a camera image departs from the scope of the present disclosure, a detailed description thereof will be omitted.

When there is a slope on the ground where the parking space 310 is located with respect to the vehicle, the parking guide line adjuster 220 provides an adjusted parking guide line 920 by rotating the current parking guide line 910 in the direction of the slope to match the slope of the ground.

When the slope changes as the vehicle is parked, the parking guide line adjuster 220 readjusts the parking guide line based on the changing slope.

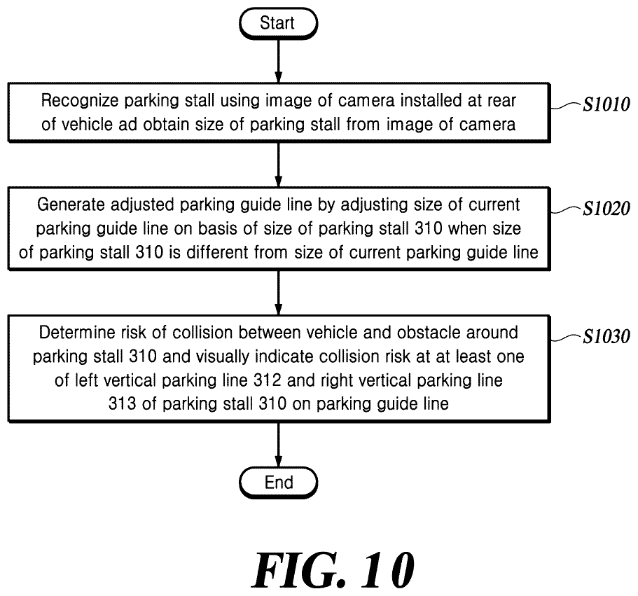

FIG. 10 is a flowchart illustrating a method of providing a parking guide line according to an embodiment of the present disclosure.

Hereinafter, a method of providing a parking guide line according to the present embodiment performed by the parking guide line providing apparatus 200 will be described with reference to FIG. 2 to FIG. 10.

The parking space recognizer 210 recognizes a parking space using an image of a camera installed at the rear of the vehicle, and performs a parking space recognition process of obtaining the size of the parking space from the image of the camera (S1010).

The parking guide line adjuster 220 performs a parking guide line adjustment process of generating an adjusted parking guide line by adjusting the size of the current parking guide line based on the size of the parking space 310 when the size of the parking space 310 is different from the size of the current parking guide line (S1020).

The collision risk indicator 230 determines a risk of collision between the vehicle and an obstacle around the parking space 310, and performs a collision risk indication process of visually indicating a collision risk at at least one of the left vertical parking line 312 and the right vertical parking line 313 of the parking space 310 on the parking guide line (S1030).

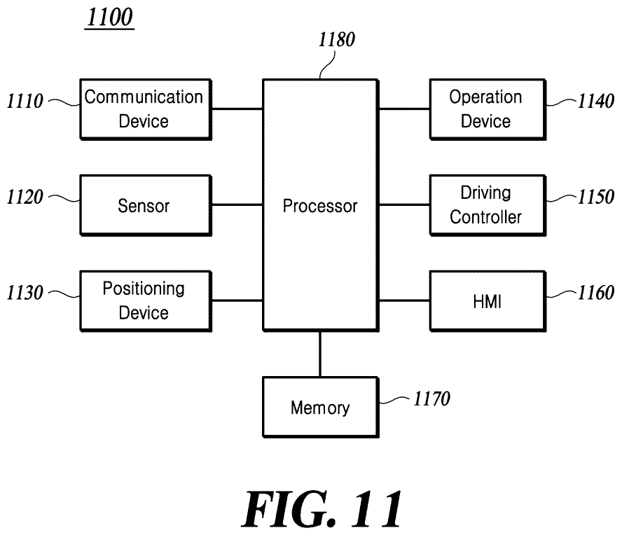

FIG. 11 is a block diagram schematically illustrating an example vehicle that can be used to implement the method or device according to embodiments of the present disclosure. The vehicle 1100 may include at least one of a communication device 1110, a sensor 1120, a positioning device 1130, an operation device 1140, a driving controller 1150, a human machine interface unit (HMI) 1160, a memory 1170, and a controller or processor 1180. The vehicle 1100 may include a parking guide line generation control device 200 structurally and/or functionally.

The communication device 1110 may exchange signals with devices positioned outside and inside the vehicle 1100. The communication device 1110 may exchange a signal with at least one of an infrastructure device such as a server or a base station, another vehicle, and a terminal. The communication device 1110 may include at least one of a transmission antenna, a reception antenna, a radio frequency (RF) circuit capable of implementing various communication protocols, and an RF element to perform communication. The communication device 1110 may include an internal communication part and an external communication part. The internal communication part may transmit or receive signals using various communication protocols present in the vehicle 1100. In this regard, an internal communication protocol may include at least one of a controller area network (CAN), a CAN with flexible data rate (CAN FD), ethernet, local interconnect network (LIN), and FlexRay. The communication protocol may include other protocols for performing communication between various devices mounted on the vehicle. The external communication part may perform communication with other vehicles, an infrastructure system, a base station, or a roadside device using various communication protocols. In this regard, the external communication protocol may include vehicle-to-everything (V2X) communication including vehicle-to-vehicle (V2V) communication, vehicle-to-infrastructure (V2I) communication, vehicle-to-network (V2N) communication, and vehicle-to-pedestrian (V2P) communication. The infrastructure may be, for example, a roadside unit or server that periodically transmits traffic information in conjunction with a transportation information system (TIS) or an intelligent transport system (ITS).

The sensor 1120 may sense the state of the vehicle 1100 and an external object. In order to sense the state of the vehicle 1100, the sensor 1120 may include at least one of an inertial measurement unit (IMU), a distance measuring instrument (DMI), a collision sensor, a wheel sensor, a speed sensor, an inclination sensor, a weight detection sensor, a heading sensor, a position module, a vehicle forward/reverse sensor, a battery sensor, a fuel sensor, a tire sensor, a steering sensor, a temperature sensor, a humidity sensor, an ultrasonic sensor, an illuminance sensor, and a pedal position sensor. On the other hand, the IMU sensor may include one or more of an acceleration sensor, a gyro sensor, and a magnetic sensor. The sensor 1120 may generate state data of the vehicle, based on a signal generated from at least one sensor. For example, direction information such as the heading and yaw rate of the vehicle 1100 may be collected by the sensor 1120.

In order to sense the external object, the sensor 1120 may include at least one of a camera, a radar sensor, a light detection and ranging (LiDAR) sensor, an ultrasonic sensor, and an infrared sensor. The sensor 1120 may measure at least one of information about the presence or absence of an object, information about a position of an object, information about a distance between the vehicle 1100 and an object, and information about relative speed between the vehicle 1100 and an object.

The positioning device 1130 may generate position data of the vehicle 1100. The positioning device 1130 may include at least one of a global positioning system (GPS), a differential global positioning system (DGPS), or a global navigation satellite system (GNSS). The positioning device 1130 may generate the position data of the vehicle 1100 based on a signal generated from at least one of the GPS, the DGPS, or the GNSS. The positioning device 1130 may estimate the position of the vehicle 1100 based on wireless signals received from the communication device 1110. The positioning device 1130 may estimate the current position of the vehicle 1100 based on the previous position, travel distance information, moving time information, speed information, or acceleration information of the vehicle 1100 using the IMU or DMI. Meanwhile, the processor 1180 may estimate the path history and path prediction of the vehicle 1100 based on the position information of the vehicle 1100 collected by the positioning device 1130.

The operation device 1140 receives a user input for driving. In a manual mode, the vehicle 1100 may be driven based on a signal provided by the operation device 1140. The operation device 1140 may include a steering input device such as a steering wheel, an acceleration input device such as an accelerator pedal, and a brake input device such as a brake pedal.

The driving controller 1150 is a device that electrically controls various vehicle driving devices in the vehicle 1100. The driving controller 1150 may include a power train driving control device, a chassis driving control device, a door/window driving control device, a safety device driving control device, a lamp driving control device, and an air conditioning driving control device. The driving controller 1150 controls the movement of the vehicle 1100 based on the input signal of the operation device 1140 or the control signal of the processor 1180.

The HMI 1160 is a device for communication between the vehicle 1100 and a human (e.g., an occupant of the vehicle 1100 or other vehicle). The HMI 1160 may receive a user input and provide information generated in the vehicle 1100 to the user. The vehicle 1100 may implement a user interface (UI) or user experience (UX) through the HMI 1160. The HMI 1160 may include an input device such as a touch panel or a microphone, and the HMI 1160 may include an output device such as a display device or a speaker. For example, the HMI 1160 may include an interior display that outputs a screen toward the inside of the vehicle 1100 and/or an exterior display that outputs a screen toward the outside of the vehicle.

The memory 1170 may store a program that causes the processor 1180 to perform a method according to an embodiment of the present disclosure. For example, the program may include a plurality of instructions executable by the processor, and the method according to an embodiment of the present disclosure may be performed by executing the plurality of instructions by the processor.

The memory 1170 may be a single memory or a plurality of memories. When the memory 1170 is formed of the plurality of memories, the plurality of memories may be physically separated. The memory 1170 may include at least one of a volatile memory and a non-volatile memory. The volatile memory includes a static random access memory (SRAM) or a dynamic random access memory (DRAM), while the non-volatile memory includes a flash memory.

The memory 1170 may store map information. The map information may be a navigation map and/or a high definition map (HD map). The HD map may be received from an external device or stored in advance. The navigation map includes a node indicating a point where at least two roads meet and a link connecting two nodes. The navigation map may include geographic information, road information, lane information, building information, or signal information. The HD map incorporates more specific data compared to the navigation map. The ADAS map may include road gradient, road curvature, or sign information, based on a road. The HD map may include lane information, lane boundary information, stop line position, traffic light position, signal sequence, or intersection information, based on a lane. The HD map may include basic road information, surrounding environment information, detailed road environment information, or dynamic road condition information. The detailed road environment information may include static information such as elevation of terrain, curvature, lane, lane centerline, regulation line, road boundary, road centerline, traffic sign, road surface sign, shape and height of the road, lane width, and the like. The dynamic road condition information may include traffic congestion, an accident section, a construction section, and the like. The HD map may include road surrounding environment information implemented in 3D, geometric information such as road shape or facility structure, and semantic information such as traffic signs or lane marks.

The processor 1180 may include at least one core capable of executing at least one command. The processor 1180 may execute the instructions stored in the memory 1170. The processor 1180 may be a single processor or a plurality of processors.

The apparatus or method according to an exemplary embodiment of the present disclosure may include the respective components provided to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations may include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) include instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Furthermore, the computer-readable recording medium can be distributed in computer systems connected via a network, wherein the computer-readable codes can be stored and executed in a distributed mode.

Although the steps in the respective flowcharts are described to be sequentially performed, they merely instantiate the technical idea of various exemplary embodiments of the present disclosure. Therefore, a person having ordinary skill in the pertinent art could perform the steps by changing the sequences described in the respective flowcharts or by performing two or more of the steps in parallel, and hence the steps in the respective flowcharts are not limited to the illustrated chronological sequences.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B”or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for providing a parking guide line through a display device of a vehicle, the apparatus comprising:
at least one memory configured to store instructions; and
at least one processor,
wherein the at least one processor executes the instructions for causing the processor to perform the steps of:
recognizing a parking space using an image from a camera installed at the rear of a vehicle, and obtaining a size of the parking space from the image;
generating an adjusted parking guide line by adjusting a size of a current parking guide line based on the size of the parking space, when the size of the parking space is different from the size of the current parking guide line; and
displaying the adjusted parking guide line on the display device.

2. The apparatus of claim 1, wherein generating the adjusted parking guide line comprises increasing a horizontal width of the current parking guide line to a first horizontal width of the parking space to generate the adjusted parking guide line if the first horizontal width of the parking space is greater than a second horizontal width of the current parking guide line, and reduces the horizontal width of the current parking guide line to the first horizontal width to generate the adjusted parking guide line if the first horizontal width is less than the second horizontal width.

3. The apparatus of claim 1, wherein generating the adjusted parking guide line comprises adjusting a length of the current parking guide line based on a first length of the parking space to generate the adjusted parking guide line.

4. The apparatus of claim 1, wherein obtaining the size of the parking space comprises recognizing a wheel stop in the image, and recognizes the wheel stop as a rear horizontal parking line of the parking space.

5. The apparatus of claim 4, wherein obtaining the size of the parking space comprises, when a plurality of wheel stops are recognized from the image, identifying the wheel stop closest to in a forward direction from the parking space as the rear horizontal parking line.

6. The apparatus of claim 1, wherein obtaining the size of the parking space comprises recognizing a left vertical parking line and a right vertical parking line in the image, and recognizing a line connecting a forward starting point of the left vertical parking line and a forward starting point of the right vertical parking line as a front horizontal parking line of the parking space.

7. The apparatus of claim 1, wherein obtaining the size of the parking space comprises recognizing a left T-line and a right T-line formed in a T shape from the front to the rear in the image, and recognizing an inner area between the left T-line and the right T-line as the parking space.

8. The apparatus of claim 1, wherein obtaining the size of the parking space comprises recognizing a left vertical parking line and a right vertical parking line in the image, and recognizing a line connecting a rearward starting point of the left vertical parking line and a rearward starting point of the right vertical parking line as a rearward horizontal parking line of the parking space.

9. The apparatus of claim 1, further comprising determining a risk of collision between the vehicle and an obstacle around the parking space, and visually indicating the collision risk on the parking guide line at a location of at least one of the left vertical parking line and the right vertical parking line of the parking space.

10. The apparatus of claim 9, wherein visually indicating the collision risk on the parking guide line comprises indicating the parking guide line corresponding to the left vertical parking line and the parking guide line corresponding to the right vertical parking line with different thicknesses, based on respective degrees of the collision risk related to the left vertical parking line and the right vertical parking line.

11. The apparatus of claim 1, wherein generating the adjusted parking guide line comprises adjusting a direction of the parking guide line based on a slope on the ground where the parking space is located, when it is determined that the ground is inclined with respect to the vehicle.

12. The apparatus of claim 11, wherein generating the adjusted parking guide line comprises readjusting the parking guide line based on a change in the slope of the ground, when the slope of the ground varies as the vehicle proceeds with parking.

13. A method of providing a parking guide line through a display device of a vehicle, comprising:
recognizing, by a processor, a parking space using an image from a camera installed at the rear of a vehicle, and obtaining a size of the parking space from the image;
generating, by the processor, an adjusted parking guide line by adjusting a size of a current parking guide line based on the size of the parking space, when the size of the parking space is different from the size of the current parking guide line; and
displaying, by the processor, the adjusted parking guide line on the display device.

14. The method of claim 13, wherein generating the adjusted parking guide line comprises increasing a horizontal width of the current parking guide line to a first horizontal width of the parking space to generate the adjusted parking guide line if the first horizontal width of the parking space is greater than a second horizontal width of the current parking guide line, and reducing the horizontal width of the current parking guide line to the first horizontal width to generate the adjusted parking guide line if the first horizontal width is less than the second horizontal width.

15. The method of claim 13, wherein generating the adjusted parking guide line comprises adjusting a length of the current parking guide line based on a first length of the parking space to generate the adjusted parking guide line.

16. The method of claim 13, wherein obtaining the size of the parking space comprises recognizing a wheel stop in the image and recognizing the wheel stop as a rear horizontal parking line of the parking space.

17. The method of claim 13, further comprising determining a risk of collision between the vehicle and an obstacle around the parking space, and visually indicating the collision risk on the parking guide line at a location of at least one of the left vertical parking line and the right vertical parking line of the parking space.

18. The method of claim 17, wherein visually indicating the collision risk on the parking guide line comprises indicating the parking guide line corresponding to the left vertical parking line and the parking guide line corresponding to the right vertical parking line with different thicknesses, based on respective degrees of the collision risk related to the left vertical parking line and the right vertical parking line.

19. The method of claim 13, wherein generating the adjusted parking guide line comprises adjusting a direction of the parking guide line based on a slope on the ground where the parking space is located, when it is determined that the ground is inclined with respect to the vehicle.

20. The method of claim 19, wherein generating the adjusted parking guide line comprises readjusting the parking guide line based on a change in the slope of the ground, when the slope of the ground varies as the vehicle proceeds with parking.
